(19) United States
(12) Patent Application Publication
(10) Pub. No.: US 2003/0225966 A1
(43) Pub. Date: Dec. 4, 2003

(54) Serverless network data storage operation managed by peripheral device

(76) Inventor: Jorgen Frandsen, Boulder, CO (US)

Correspondence Address: NIXON & VANDERHYE P.C., 8th Floor, 1100 North Glebe Road, Arlington, VA, 22201, US

(21) Appl. No.: 10/158,195

(22) Filed: May 31, 2002

(51) Int. Cl. G06F 12/00

(52) U.S. Cl. 711/111; 711/162

(57) ABSTRACT

A peripheral device includes a data operation controller (40) which manages a serverless network data storage operation for either writing data (e.g., backing up data) or reading data (e.g., restoring backed-up data). In an example embodiment, the peripheral device is an I/O drive (26), such as a magnetic tape drive, situated at a peripheral node of a storage area network (20). In the network data storage operation, data is obtained (under the direction of the peripheral device-resident data operation controller) from a source drive storage medium at a source drive, transmitted through the peripheral device's interface with the storage network, and then recorded (under the direction of the peripheral device-resident data operation controller) by a destination drive on a destination drive storage medium. In one embodiment in which the peripheral device that has the data operation controller is an I/O drive, the medium handled by the I/O drive can be the medium on which data is written or from which data is read. Thus, the I/O drive which has the data operation controller can itself be the destination drive for a write (e.g., backup) procedure or the source drive for a read (e.g., restore) procedure. In other embodiments, the I/O drive that has the data operation controller need not be either the destination drive nor the source drive, as both the destination drive and the source drive can be external drives of the storage area network (e.g., situated on the storage network at nodes apart from a node whereat the I/O drive resides).

### BACKGROUND

I. Field of the Invention

The present invention pertains to the storage of information, and particularly to transfer of information from a first storage medium to a second storage medium, such as a transfer involved in a backup/archive operation or a restore operation.

II. Related Art and Other Considerations

Computer-generated and/or computer-utilized information, whether executable program instructions or data, must be stored in some type of memory. Information that should be readily available to a processor is typically stored in some type of fast memory, such as a semiconductor memory. Examples of semiconductor memories are random access memory (RAM) chips and read only memory (ROM) chips, the former being susceptible of both write and read operations. While semiconductor memories are among the fastest memory devices, other media is also widely utilized for information storage, such as CD ROM, disk (magnetic or optical), and magnetic tape.

Disks are handled by disk drives which provide essentially random access to locations (defined, e.g., by cylinder, sector, and track) for transducing information (e.g., either recording/writing or reproducing/reading). A disk drive array may comprise a plurality of disks that are accessed by the disk drive.

Magnetic tape, among the earliest forms of memory media, continues to be a cost effective and long-term media for information storage. In early years magnetic tape was wound on large reels that were mounted in cabinet-sized tape drives. For the last several decades magnetic tape has preferably been housed in a small cassette or cartridge. There are cartridges/cassettes of differing sizes, media types, and configurations (e.g., cartridges having one or two reels). The cartridges are easily insertable into a tape drive, nowadays of relative small form factor, for the sequential transducing of information to and from the media. Information can be transduced relative to the media in one of a variety of formats, such as (for example) longitudinal tracks or helical tracks.

Magnetic tape is a proven media for the long-term backup and archiving of information. As used herein, “backup” or “archive” should also be understood to encompass the essentially inverse procedure, e.g., restoration of reading of data from the backup medium. Backup (and restoration) have been practiced for information stored on computers and computer systems, whether small or large. For example, laptop and desktop computers can be “backed up” when connected to small tape drives (about the size of an audio cassette player). At operator request, a “driver” backup application program can be executed by the computer to store selected or all files from the computer's hard drive on the magnetic tape handled by the tape drive.

Backup is also practiced for networks of computers, so that the information stored on hard disks and/or disk arrays of network servers is copied on magnetic tape. Such networks may comprise, e.g., network nodes which are connected by appropriate connectors (e.g., fiber). In some instances certain intermediate nodes known as switches or fabrics may be employed to route information between nodes.

Many cassettes or cartridges of magnetic tape may be required to backup an entire large network. Multi-cartridge backup entails either human intervention for inserting and retrieving cartridges from the tape drive, or some type of robotics which performs the cartridge manipulation relative to the tape drive. In fact, for large systems a cartridge library may be utilized. Cartridge libraries are of varying sizes, some resembling juke box-type apparatus. Typically a cartridge library has one or more tape drives, a rack for housing plural cartridge magazines, and a robot or “gripper” which transports cartridges between the drive(s) and magazines. The following US patents and patent applications, all commonly assigned herewith and incorporated herein by reference, disclose various configurations of automated cartridge libraries, as well as subcomponents thereof (including cartridge engagement/transport mechanisms, entry/exit ports, and storage racks for housing cartridges): U.S. Pat. No. 4,984,106; U.S. Pat. No. 4,972,277; U.S. Pat. No. 5,059,772; U.S. Pat. No. 5,237,467; U.S. Pat. No. 5,416,653; U.S. Pat. No. 5,498,116; U.S. Pat. No. 5,487,579; U.S. Pat. No. 5,718,339; U.S. Pat. No. 6,008,964; U.S. Pat. No. 6,005,745; U.S. Pat. No. 6,239,941; and, U.S. Pat. No. 6,144,521.

Although there are many ways of connecting a tape drive to a computer, for years a popular practice was to use a SCSI interface. In particular, a SCSI interface device (e.g., SCSI controller) was housed in the tape drive to facilitate communication over a SCSI bus cable with the computer. More recent, fiber channel interface devices have been employed as an augmentation to the SCSI interface, particularly as tape drives have become incorporated into storage area networks (SANs).

Tape backup has become more sophisticated in recent years. The sophistication began with network servers or the like being preconfigured automatically to execute backup application programs at periodic intervals. The backup application programs executed by the server essentially initiate and coordinate the backup of information. For example, the server-executed backup application programs both (1) command the disk drives to access, read, and convey to the server the appropriate information from the disk(s) (or disk arrays), and (2) command the tape drive(s) to record the disk-obtained information which had been conveyed to the server.

Unfortunately, backup operations typically consume an inordinate amount of server resources. For example, over one third or even one half of a server's processing power may be devoted to backup operations, thereby significantly decreasing server utilization for other tasks. For such reasons, backup operations have historically been scheduled for performance at night, or other anticipated non-peak times of network activity.

Data backup sophistication accelerated with the advent of serverless backup. In serverless backup, the network server merely initiates (starts and prescribes certain parameters for) the backup procedure. The network server initiates the serverless backup by sending a command (commonly known as the EXTENDED COPY command) over a communications network to another entity that controls the serverless backup operation. In other words, the server essentially starts the serverless backup without the server having to be involved with issuing individual commands to the disk drive or tape drive for manipulating the respective media, and without the server requiring that the information-to-be-backed up to be routed through the server.

In serverless backup, heretofore the drive-coordinating logic for serverless backup has been executed by a processor residing in a switch (fabric) or router of the network, or (alternatively) in a dedicated device known as a “bridge” which can be situated in and form a separate part of a cartridge library. For example, in a cartridge library having eight tape drives, the bridge essentially simultaneously manages the serverless backup of data to all eight tape drives in the library.

The following standards are related either to the fibre channel interface devices described above or to serverless backup (using, e.g., fibre channel)

ANSI Information Technology SCSI Primary Commands-2 (SPC-2), T10/1236-D, Revision 18;

ANSI Information Technology SCSI Primary Commands-2 (SPC-2), T10/1236-D, Revision 19;

Extended Copy Command, T10/99-143r1 Proposal;

ANSI Information Technology SCSI-3 Stream Device Commands (SSC), X3T10/1997D, Revision 22.November 2001;

ANSI Information Technology Fibre Channel Protocol for SCSI (FCP), X3.269-1996;

ANSI Information Technology Fibre Channel Protocol for SCSI, Second Revision 2 (FCP-2), T10/Project 1144-D/Rev 4, December 1999;

ANSI Information Technology Fibre Channel Physical and Signaling Standard (FC-PH), X3.230-1994;

ANSI Information Technology Fibre Channel 2nd Generation Physical and Signaling Standard (FC-PH-2), X3.303-1998;

ANSI Information Technology Fibre Channel Arbitrated Loop (FC-AL), X3.272-1996;

ANSI Information Technology Fibre Channel Arbitrated Loop (FC-AL-2), NCITS 332-1999;

Information Technology Fibre Channel Fabric Loop Attachment (FC-FLA), T11/Project 1235-DT/Rev 2.7;

Fibre Channel FC-Tape Standard, T11/99, 069v4, 1999;

Fibre Channel Tape Connector Profile Using 80-pin SCA-2 Connector, T11/99, 234v2;

Specification for 40-pin SCA-2 Connector w/Bidirectional ESI, SFF-8067;

Specification for 40-pin SCA-2 Connector w/Parallel Selection, SFF-8045;

SCA-2 Unshielded Connections, EIA-700AOAE (SFF-8451)

Gigabit Interface Converter (GBIC), Small Form Factor, SFF-8053, Revision 5.x;

Common FC-PH Feature Sets Profiles, Fibre Channel Systems Initiative, FCSI-101-Rev. 3.1;

SCSI Profile, Fibre Channel System Initiative, FCSI-201-Rev. 2.2;

FCSI IP Profile, Fibre Channel System Initiative, FCSI-202-Rev. 2.1.

Utilization of a conventional backup management agent (located, e.g., either in a server, in a bridge, or in a switch) typically slows down data transfer in the storage drives involved in the backup procedure (or, conversely, in the restoration procedure). Commonly the data transfer rates for drives involved in backup operations managed by conventional backup agents are well below the native transfer speeds of the drive (e.g., are considerably below the transfer speeds of which the drive is capable).

Moreover, when using conventional serverless backup agents (e.g., fabric-based or bridge-based), a bottleneck situation can occur in an information storage library that has plural drives. For example, if there are eight tape drives of the library involved in the serveless backup, at any given time the fabric or bridge may control as many as eight different data streams. A bottleneck in one of the data streams can easily lead to inefficiency with respect to the other data streams, and thus inefficiency of the overall backup operation.

Therefore, what is needed, and an object of the present invention, is a serverless network data storage operation and apparatus therefor that makes efficient use of drives involved in the operation.

### BRIEF SUMMARY

A peripheral device includes a data operation controller which manages a serverless network data storage operation for either writing data (e.g., backing up data) or reading data (e.g., restoring backed-up data). In an example embodiment, the peripheral device is an I/O drive, such as a magnetic tape drive, situated at a peripheral node of a storage area network. In the network data storage operation, data is obtained (under the direction of the peripheral device-resident data operation controller) from a source drive storage medium at a source drive, transmitted through the peripheral device's interface with the storage network, and then recorded (under the direction of the peripheral device-resident data operation controller) by a destination drive on a destination drive storage medium.

In one embodiment in which the peripheral device that has the data operation controller is an I/O drive, the medium handled by the I/O drive can be the medium on which data is written or from which data is read. Thus, the I/O drive which has the data operation controller can itself be the destination drive for a write (e.g., backup) procedure or the source drive for a read (e.g., restore) procedure. In other embodiments, the I/O drive that has the data operation controller need not be either the destination drive nor the source drive, as both the destination drive and the source drive can be external drives of the storage area network (e.g., situated on the storage network at nodes apart from a node whereat the I/O drive resides).

The network data storage operation, also known as an extended copy data operation, is initiated upon issuance of an EXTENDED COPY command. The EXTENDED COPY command can specify or define plural segments of activity involved in the network data storage operation, with each segment possibly involving a different combination of destination and source devices/drives. Thus, the network data storage operation can involve writing/backup from plural external drives, and conversely reading/restoration to plural external drives.

External drives involved in the network data storage operation include one or more disk drives, including a disk drive at a server of the storage area network as well as disk drive(s) situated at node(s) of the storage network which is/are distinct from a node whereat the server resides. In addition, one or more external drives involved in the network data storage operation may be a tape drive.

By situating the data operation controller in the I/O drive, at or near native data transfer rates for the I/O drive can be achieved during the serverless network data storage operation.

As another aspect, a cartridge library includes plural I/O drives, each of which has a data operation controller for performing the network data storage operation. In having its own data operation controller, each I/O drive can handle its own data stream for the network data storage operation and thereby avoid bottlenecks to which libraries are otherwise susceptible when all data flows are commonly handled.

### BRIEF DESCRIPTION OF THE DRAWINGS

The foregoing and other objects, features, and advantages of the invention will be apparent from the following more particular description of preferred embodiments as illustrated in the accompanying drawings in which reference characters refer to the same parts throughout the various views. The drawings are not necessarily to scale, emphasis instead being placed upon illustrating the principles of the invention.

FIG. 1 is a schematic view of a storage area network including peripheral device which manages a serverless network data storage operation.

FIG. 2 is a schematic view of a storage area network including a cartridge library having plural peripheral devices, each of which manages a serverless network data storage operation.

FIG. 3 is a schematic view showing various functionalities involved in a serverless network data storage operation.

FIG. 3A is a diagrammatic view showing basic actions performed in conjunction with a backup procedure of a serverless network data storage operation wherein a peripheral device which manages the backup procedure is a destination device for the backup procedure.

FIG. 3B is a diagrammatic view showing basic actions performed in conjunction with a restore procedure of a serverless network data storage operation wherein a peripheral device which manages the restore procedure is a source device for the restore procedure.

FIG. 4A is a diagrammatic view showing basic actions performed in conjunction with a backup procedure of a serverless network data storage operation wherein a peripheral device which manages the backup procedure is not a destination device for the backup procedure.

FIG. 4B is a diagrammatic view showing basic actions performed in conjunction with a restore procedure of a serverless network data storage operation wherein a peripheral device which manages the restore procedure is a not source device for the restore procedure.

FIG. 5 is a diagrammatic view of example contents of a EXTENDED COPY command.

FIG. 6 is a diagrammatic view showing certain states of a parameter list parser of the data operation controller.

FIG. 7 is a diagrammatic view showing certain states of a source state machine and a destination state machine of a data operation controller.

FIG. 8 is a schematic view of an example generic tape drive suitable for managing a serverless network data storage operation.

FIG. 9 is a schematic view of an example helical scan tape drive suitable for managing a serverless network data storage operation.

### DETAILED DESCRIPTION OF THE DRAWINGS

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other embodiments that depart from these specific details. In other instances, detailed descriptions of well known devices, circuits, and methods are omitted so as not to obscure the description of the present invention with unnecessary detail.

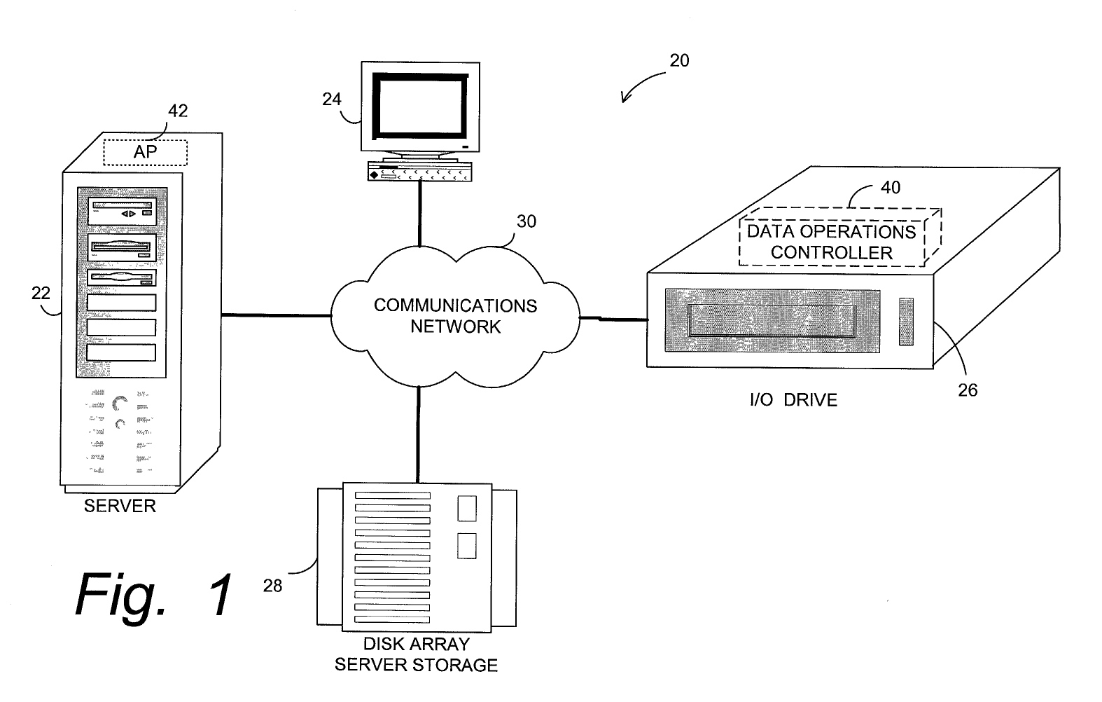

FIG. 1 shows an example storage area network 20 which features a network data storage operation managed by a peripheral device which comprises the network. As a non-limiting example, the peripheral device is an information storage drive (e.g., I/O drive). Basic example, representative constituents of storage area network 20 include network server 22; workstation or terminal 24; a first information storage drive (I/O drive) 26 which transduces information relative to a first storage medium storage; a second information storage drive (such as a drive for a disk array 28) which transduces information relative to a second storage medium storage (e.g., magnetic or optical disk); and, communications network 30. The elements of storage area network 20 are not necessarily shown to scale in FIG. 1, the peripheral device embodied in the form of I/O drive 26 (for example) being enlarged for facilitating illustration of a data operation controller 40 which manages the network data storage operation.

It will be appreciated that, for sake of simplicity of illustration, only example, representative elements of storage area network 20 are depicted in FIG. 1. In actuality, storage area network 20 may comprise plural instances of each of the elements shown in FIG. 1, such as one or more of each of the following: plural network servers 22, plural workstations 24, plural I/O drives 26, and plural disk arrays 28.

The I/O drive 26 and disk array 28 are examples of peripheral devices of storage area network 20, and also are examples of peripheral or end nodes of storage area network 20. By contrast, typically the communications network 30 has plural intermediate nodes through which data is relayed between other nodes. The intermediate nodes thus have some type of switching or routing capability and are connected to at least two nodes of storage area network 20 by two respective physical links. Generally a peripheral node is physically connected only to one other node of a network.

The data operation controller 40 described herein is thus located in a peripheral device (e.g., an I/O drive) situated at a peripheral node of storage area network 20. In one aspect, the I/O drive is a backup/restore device that handles media on which data is written or recorded (e.g., for data backed up during a backup procedure), or from which data is read (e.g., for data restored during a restore procedure). Although in an illustrated non-limiting example embodiment the I/O drive is a tape drive 26, it will be appreciated that the I/O drive that has the data operation controller 40 can be another type of I/O drive, e.g., a disk drive, rewriteable DVD drive, or the like.

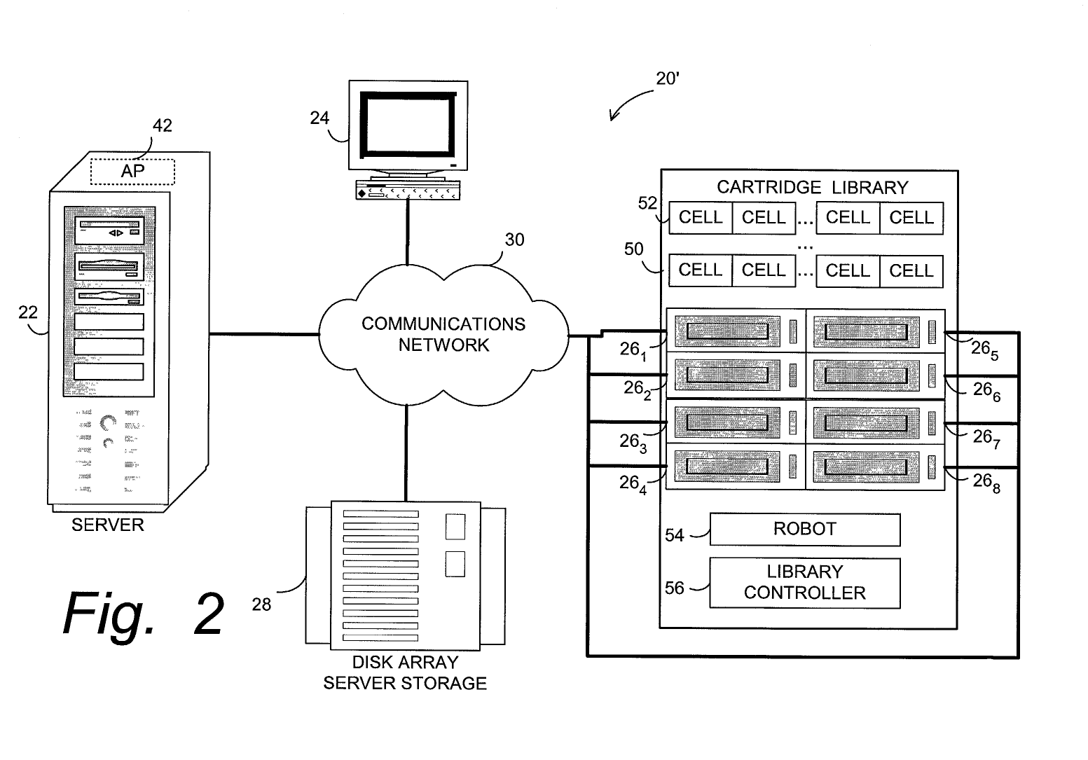

FIG. 2 shows another example storage area network 20′ which is comprised by network server 22; workstation or terminal 24; disk array 28; and communications network 30. Rather than having just one I/O drive which includes a data operation controller 40, the storage area network 20′ of FIG. 2 has eight I/O drives situated in a cartridge library 50. In the illustrated embodiment, these eight I/O drives are illustrated as 26₁-26₈. In addition to the I/O drives 26, the cartridge library 50 comprises plural compartments or cells 52 for accommodating the unillustrated cartridges, as well as a picker mechanism or robot 54 which transports cartridges between the tape drives 26 and the cells 52. Further, the cartridge library 50 has its own library controller 56 which governs the robot 54 and interfaces with the I/O drives 26. Examples of suitable libraries include those previously listed.

The data operation controller 40 manages the serverless network data storage operation, and thus serves, e.g., as the “manager” or “agent”. The data operation controller 40 is situated in and comprises part of the I/O drive, as shown in the FIG. 1 embodiment. For a library embodiment such as shown in FIG. 2, each of the plural I/O drives 26 has its own data operation controller 40.

The serverless network data storage operation is commenced in response to a special command, herein known as the EXTENDED COPY command, issued from network server 22. In particular, the EXTENDED COPY command is issued by an applications program (AP) 42 which is executed by network server 22. Issuance of the EXTENDED COPY command by applications program (AP) 42 may be prompted by user input at workstation 24, for example. As such, the network server 22 is viewed as the “application client.”

Although applications program (AP) 42 issues the EXTENDED COPY command, data operation controller 40 actually initiates and manages performance of the serverless network data storage operation, as hereinafter explained. In the serverless network data storage operation, a “target device” is that which receives read and write commands from I/O drive 26 during the serverless network data storage operation, and which either receives data from or supplies data to I/O drive 26 during the serverless network data storage operation. The target device is typically a device such as disk array 28, but may be the network server 22 itself. When the target device is not the I/O drive 26, the target device is said to be an “external device.”

For conciseness, the serverless network data storage operation is sometimes referenced herein as the “extended copy” or “Ecopy” operation. The serverless network data storage operation can be either a write (e.g., backup) procedure or a read (e.g., restore) procedure. In the ensuing discussion, “write” and “backup” are used essentially interchangeably as referring to both, although the person skilled in the art will appreciate that a backup procedure is just one type of write procedure. Similar considerations apply for “read” and “restore”.

In the write or backup procedure, data is obtained from the second storage medium (e.g., the disk via disk array 28) and recorded on the first storage medium (e.g., the media of the I/O drive 26 (magnetic tape, for example)). Thus, in the write or backup procedure, the second storage medium has the “source” data which is transferred via communications network 30 to the first information storage device where it becomes destination data for recording on the first storage medium.

In the read or restore procedure, source data is obtained from the first storage medium (e.g., the media of I/O drive 26) and transferred (via communications network 30) to the second information storage device as destination data for recording on the second storage medium (e.g., the disk via disk array 28). Both the write/backup procedure and the read/restore procedure are performed under control and management of the manager, i.e., the I/O drive 26. Both the backup procedure and the restore procedure are performed without conveyance of the data through the server 22, or at least without conveyance of the data through a processor of the server 22.

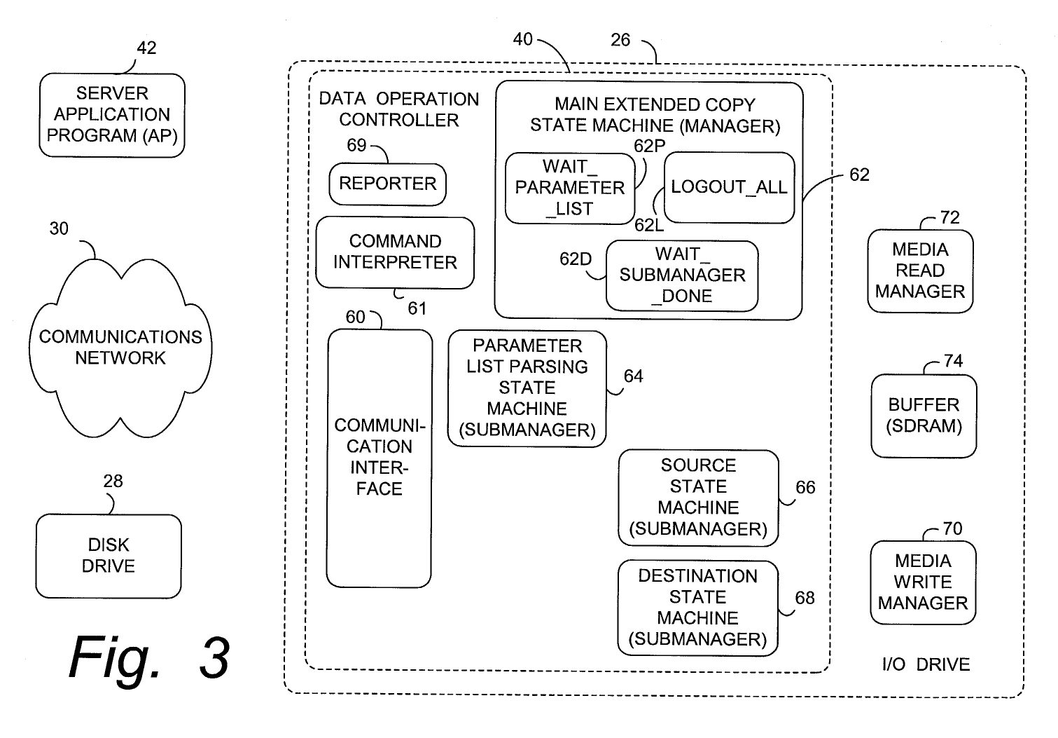

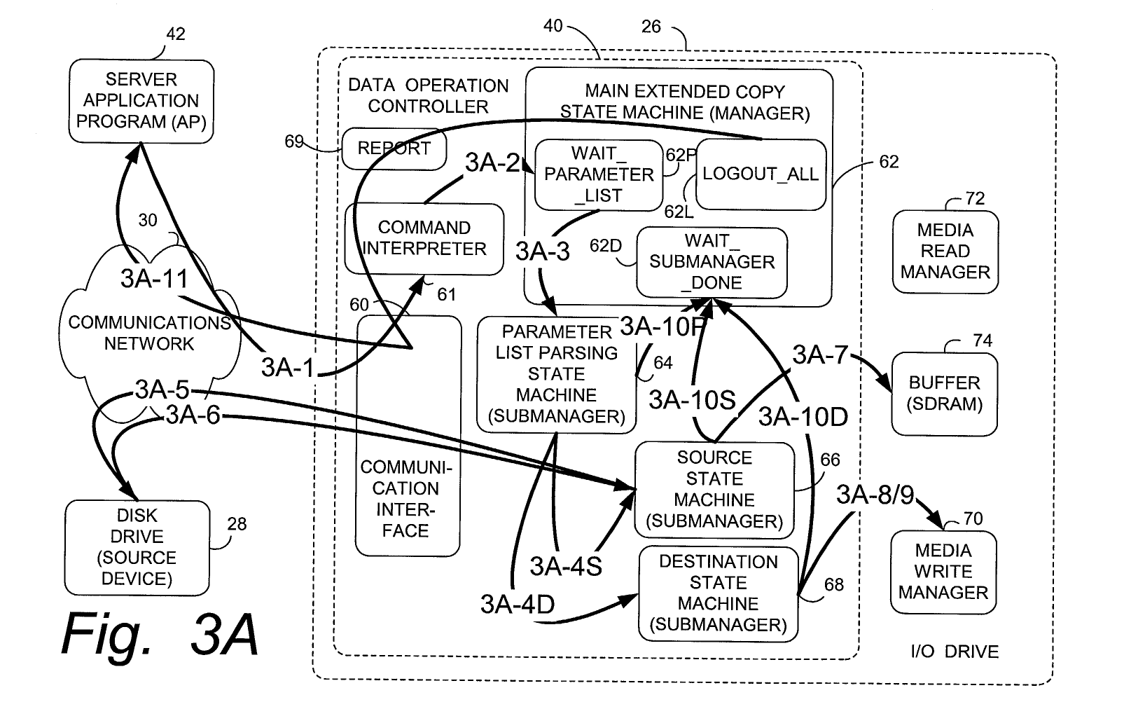

As indicated above, the data operation controller 40 is situated at I/O drive 26. FIG. 3 shows various example functional aspects of data operation controller 40. Among the functional aspects of data operation controller 40 illustrated in FIG. 3 are communication interface 60; command interpreter 61; and main extended copy state machine 62. The main extended copy state machine 62 is also known as the “manager” 62, in view of the fact that it manages, e.g., various other state machines (each known as “submanagers”). Those other state machines/submanagers include parameter list parsing state machine 64 (also known as parameter list parser 64); source state machine 66; and destination state machine 68. The data operation controller 40 also includes a reporting function 69.

The communications interface 60 can be any interface which supports the commands (e.g., SCSI commands) herein utilized. Communication interface 60 allows multiple devices to share connections, yet operate and exchange data independently. The communication interface 60 is comprised of the physical interface and the signaling protocol used during communication. The format and content of the information carried over communication interface 60, as well as how each device uses and responds to the information, is governed by a command protocol. The command protocol determines how the host (or initiator) interacts with the target device (for example, the tape drive 26) by issuing commands, transferring data, and responding to status information. In an example implementation, the communication interface 60 is a fibre channel interface such as that described by standards and documents already referenced.

FIG. 3 also shows selected aspects of I/O drive 26 with which data operation controller 40 interacts, including media write manager 70 and media read manager 72. Both media write manager 70 and media write manager 72 access buffer 74. In the example illustrated embodiment, buffer 74 is also referred to as a SDRAM. The buffer 74 may be dedicated to data operation controller 40, or alternatively (as shown in FIG. 3) also utilized by I/O drive 26 for other purposes, such as the general buffer utilized by media write manager 70 and media read manager 72.

The source state machine 66 serves, e.g., to copy data from a source device to buffer 74. The destination state machine 68, on the other hand, serves to copy data from buffer 74 to a destination device. Which device constitutes the source device and which device constitutes the destination device depends, of course, on the direction of data flow (e.g., whether a write procedure or a read procedure is being performed).

FIG. 3 also shows that the main extended copy state machine 62 has three primary states: WAIT_PARAMETER_LIST state 62P; WAIT_SUBMANAGER_DONE state 62D; and, LOGOUT_ALL state 62L. The WAIT_PARAMETER_LIST state 62P is the main entry state of main extended copy state machine 62. In WAIT_PARAMETER_LIST state 62P, the parameter list parser 64 is kicked off and processing of the parameter list is performed. The second state of the main extended copy state machine 62 is WAIT_SUBMANAGER_DONE state 62D. In WAIT_SUBMANAGER_DONE state 62D, the main extended copy state machine 62 waits for the all of the sub-managers (parameter list parser 64, source state machine 66, and destination state machine 68) to complete. The LOGOUT_ALL state 62L is the last state of main extended copy state machine 62. Once all of the submanagers have completed their processing for this EXTENDED COPY command, all of the extended copy target devices can be logged out.

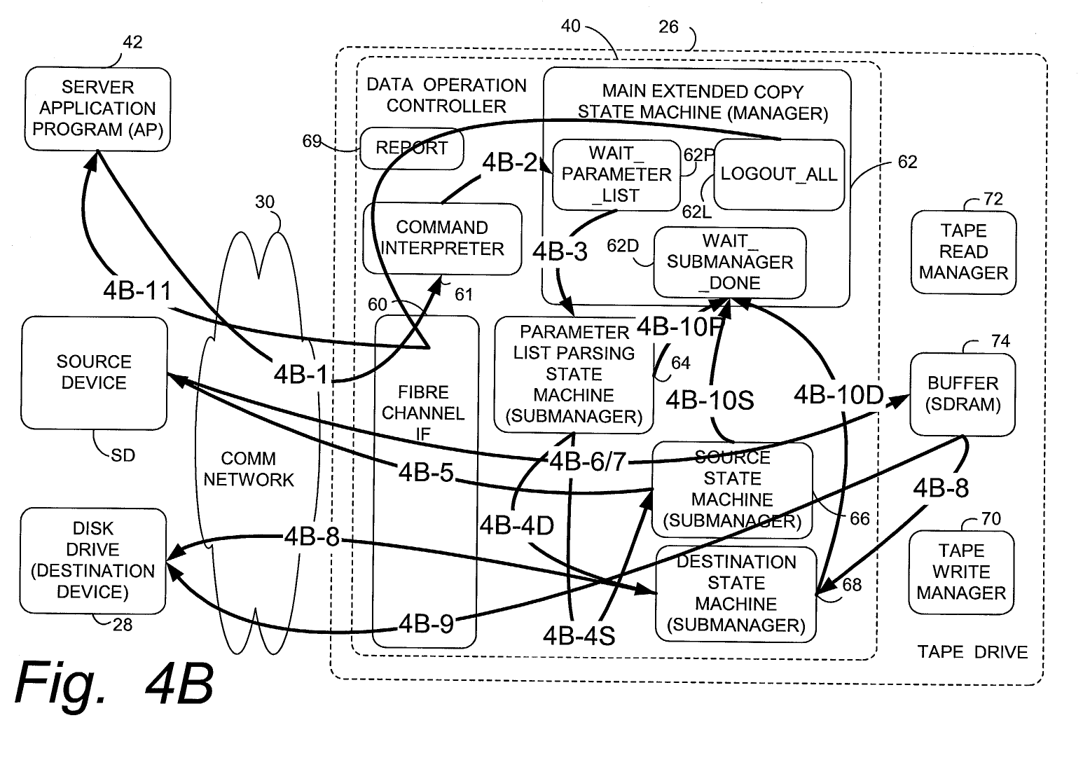

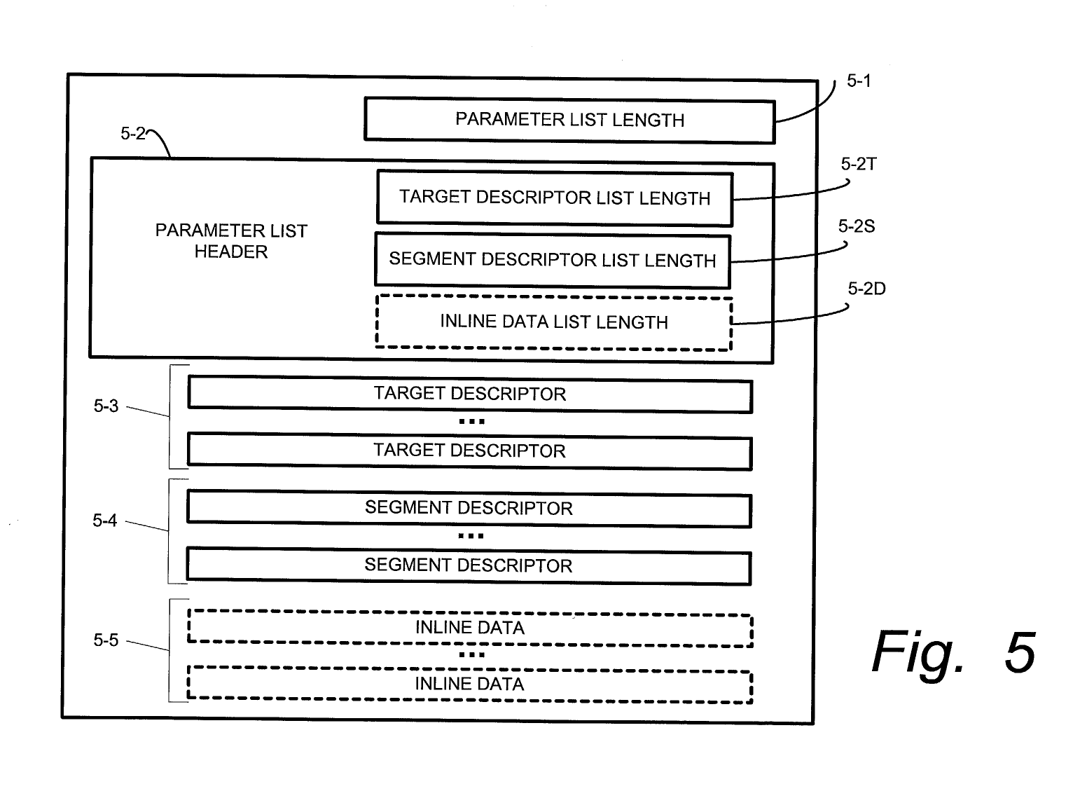

FIG. 3A shows example basic actions performed in conjunction with a representative, general write (e.g., backup) procedure of the drive-managed serverless network data storage operation in which the I/O drive 26 is a destination device for the backup procedure. Through its software applications program (AP) 42, network server 22 issues an EXTENDED COPY command shown as action 3A-1 in FIG. 3A. The EXTENDED COPY command essentially requests performance of an Ecopy backup from an external device (e.g., disk array 28 in the illustrated scenario) to tape drive 26. As explained subsequently in conjunction with FIG. 5, the EXTENDED COPY command includes a parameter list. At tape drive 26, the command interpreter 61 of data operation controller 40 interprets the EXTENDED COPY command and, as action 3A-2, forwards the command with its parameter list to main extended copy state machine 62. The first state of main extended copy state machine 62, i.e., WAIT_PARAMETER_LIST state 62P, launches parameter list parser 64 (as depicted by action 3A-3). The parameter list parser 64 parses the EXTENDED COPY command and, as a consequence thereof, as respective actions 3A-4S and 3A-4D, invokes the source state machine 66 and the destination state machine 68. In the non-limiting, illustrated embodiment, each of source state machine 66 and destination state machine 68 have intelligence to detect when they can actually initiate their respective data transfers.

In the write (e.g., backup) procedure, the source state machine 66 acts as the SCSI initiator to issue read commands (shown by action 3A-5) to the external source device (e.g., specified disks such as those in disk array 28) across communications network 30. In response to the read commands issued as action 3A-5, as action 3A-6 the external source device (e.g., disk array 28) sends the data requested by the source state machine 66. As shown by action 3A-7, source state machine 66 directs the source data from the external device to buffer 74. In view of the fact that the buffer 74 may be a DMA memory device, the source data may be travel from the external source device, through communications network 30, through the communication interface 60, and to buffer 74 without physically passing through source state machine 66. Actions 3A-6 and 3A-7 thus can be conceptualized as generally depicting flow of the source data in a logical sense.

As action 3A-8/9, the destination state machine 68 directs the transfer of the source data from buffer 74 to the destination device. In the situation shown in FIG. 3A, the destination device is I/O drive 26 itself. Therefore, action 3A-8/9 shows destination state machine 68 providing media write manager 70 with access to the data involved in the write procedure. The media write manager 70 is responsible for writing the destination data to the media handled by I/O drive 26.

After each of parameter list parser 64, source state machine 66, and destination state machine 68 have completed their operations, each sends a signal (reflected by actions 3A-10P, 3A-10S, and 3A-10D, respectively) to main machine 62. After the signals of all of actions 3A-10P, 3A-10S, and 3A-10D have been received, the LOGOUT_ALL state 62L is entered. If requested, the data operation controller 40 can provide a status report of the results of the backup operation to applications program (AP) 42 (as generally depicted by action 3A-11).

FIG. 3B shows example basic actions performed in conjunction with a representative, general read (e.g., restore) procedure of the drive-managed serverless network data storage operation in which I/O drive 26 is the source device for the restore procedure. In the restore procedure, the procedure of FIG. 3A is essentially reversed. As action 3B-1, the I/O drive 26 receives an EXTENDED COPY command with its parameter list. The EXTENDED COPY command specifies blocks of data on a source device (e.g., I/O drive 26 in the example illustrated scenario). As in the FIG. 3A procedure, at I/O drive 26, the command interpreter 61 of data operation controller 40 interprets the EXTENDED COPY command and, as action 3B-2, forwards the command with its parameter list to main extended copy state machine 62. The first state of main extended copy state machine 62, i.e., WAIT_PARAMETER_LIST state 62P, launches parameter list parser 64 (as depicted by action 3B-3). The parameter list parser 64 parses the EXTENDED COPY command and, as a consequence thereof, as respective actions 3B-4S and 3B-4D, invokes the source state machine 66 and the destination state machine 68.

In the read (e.g., restore) procedure involving reading/restoration of data stored at I/O drive 26, the source state machine 66 acts as the SCSI initiator to issue READ commands (shown by action 3B-5) to media read manager 72. The media read manager 72 obtains the source data from the media handled by I/O drive 26 (e.g., tape in an example embodiment). Storage in buffer 74 of the source data obtained by the media read manager 72 is shown as action 3B-6.

The source data now stored in buffer 74 is be transferred as destination data. Accordingly, the destination state machine 68 issues a WRITE command (see action 3B-7) to a destination device that is to receive the destination data. In the situation shown in FIG. 3B, the destination device is an external device such as disk array 28, for which reason action 3B-7 shows destination state machine 68 sending the WRITE command for the destination data via communications network 30 to disk array 28. Action 3B-8/9 reflects actual transfer of the data from buffer 74 (via communication interface 60 and communications network 30) to the destination device 28 in an embodiment in which the buffer 74 is a DMA memory device. Although not shown in FIG. 3B, acknowledgments of proper receipt can also be provided by the external device to data operation controller 40.

As in the FIG. 3A procedure, after each of parameter list parser 64, source state machine 66, and destination state machine 68 have completed their operations, each sends a signal (reflected by actions 3B-10P, 3B-10S, and 3B-10D, respectively) to main machine 62. After the signals of all of actions 3B-10P, 3B-10S, and 3B-10D have been received, the LOGOUT_ALL state 62L is entered. If requested, the data operation controller 40 can provide a status report of the results of the backup operation to applications program (AP) 42 (as generally depicted by action 3B-11).

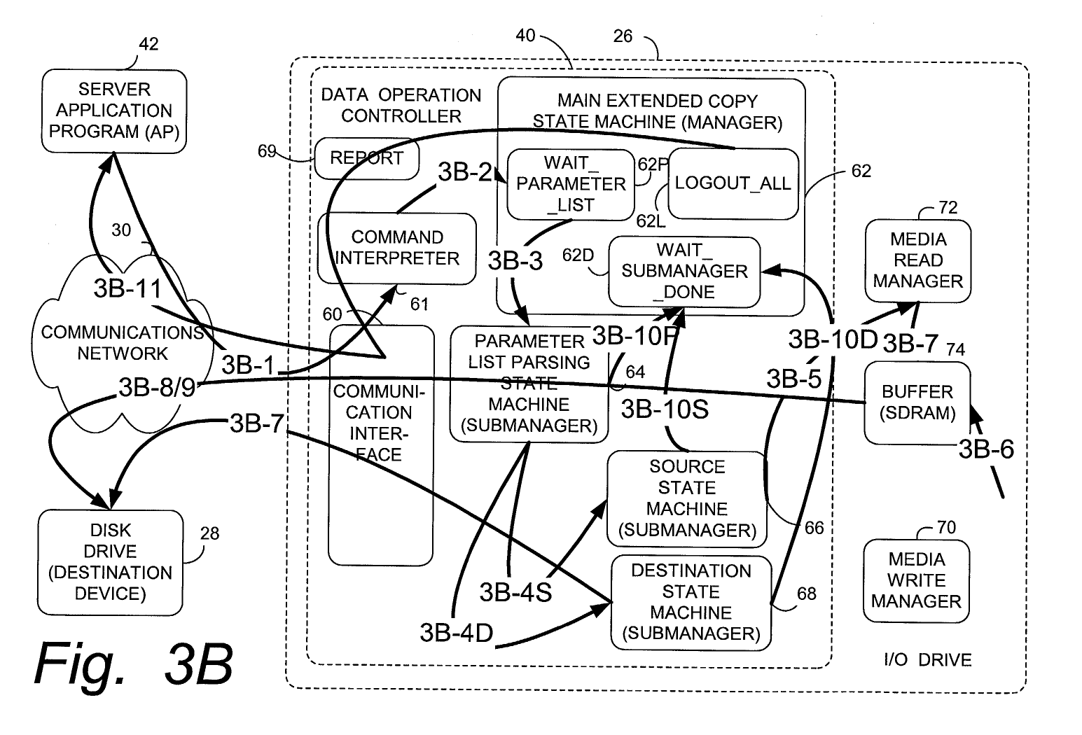

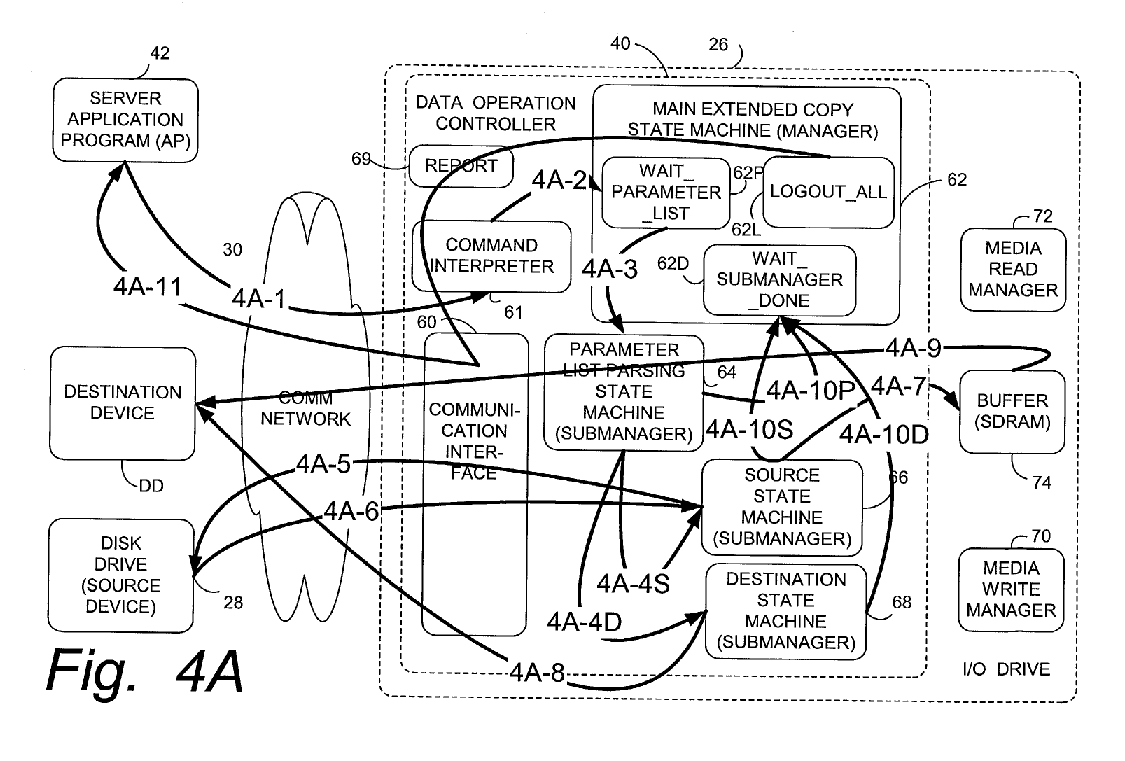

FIG. 4A shows example basic actions performed in conjunction with a representative, general backup procedure of the I/O drive-managed serverless network data storage operation in which an external destination device DD, rather than the I/O drive 26, is the destination device for the write/backup procedure. Actions 4A-1 through 4A-7 of the backup procedure of FIG. 4A resemble respective actions 3A-1 through 3A-7 of the backup procedure of FIG. 3A, with the result that data which is to be the destination data is stored in buffer 74. As action 4A-8 the destination state machine 68 issues a WRITE command to the external destination device DD to receive the destination data. The external destination device can be another disk drive or another tape drive. In FIG. 4A, the data transfer of the destination data to destination device DD is represented by action 4A-9. Again, although not shown in FIG. 4A acknowledgments of proper receipt can also be provided by the external destination device to data operation controller 40. The remaining actions 4A-10x and 4A-11 of FIG. 4A correspond to actions 3A-10x and 3A-11 of FIG. 3A.

FIG. 4B shows example basic actions performed in conjunction with representative, general read (e.g., restore) procedure of the drive-managed serverless network data storage operation in which an external source drive, rather than tape drive 26, is the source device for the restore procedure. Actions 4B-1 through 4B-4x of the restore procedure of FIG. 4B resemble respective actions 3B-1 through 3B-4x of the restore procedure of FIG. 3A. But as action 4B-5 the tape drive 26 requests the source data via communications network 30 from the external device SD. The external source device can be another disk drive or another tape drive. Action 4B-6/7 shows the external source device SD providing the source data into buffer 74 under control of source state machine 66. In buffer 74 the source data becomes destination data. As action 4B-8, destination state machine 68 issues a command to a destination device to receive the destination data. In the situation shown in FIG. 4B, the destination device is an external device such as disk array 28, for which reason action 4B-8 shows destination state machine 68 sending the command via communications network 30 to disk array 28. Action 4B-9 further shows the transfer of the destination data from buffer 74 to the destination device DD. Although not shown in FIG. 4B, acknowledgments of proper receipt can also be provided by the external destination device to data operation controller 40. The remaining actions 4B-10x and 4B-11 of FIG. 4B correspond to actions 3B-10x and 3B-11 of FIG. 3B.

Mention has been made above of the EXTENDED COPY command. In connection with the serverless network data storage operation which it manages, the tape drive 26 with its communication interface 60 actually supports essentially the same SCSI commands as a parallel SCSI tape drive with only few exceptions. The exceptions involve two additional commands (the EXTENDED COPY command and the RECEIVE COPY RESULTS command) and modification of four existing commands. These additional commands, and modifications to existing commands, are understood with reference to Table 1.

The EXTENDED COPY command enables the host (e.g., network server 22) to send a request concerning multiple copy “sessions” or segments to the copy manager target drive (e.g., tape drive 26). A segment may contain a request to copy a certain block or series of blocks of data, and a series of segments may contain the sum of a file or files for an entire EXTENDED COPY command.

When the application host issues the EXTENDED COPY command, the tape drive 26 is put into a mode that manages the movement of data between the tape drive 26 and an external device (such as disk array 28) without further interaction of the application host. Failure of the Extended COPY command will result in tape drive 26 asserting a Check Condition status to the host with appropriate sense key information.

The EXTENDED COPY command allows the tape drive to copy one or more logical blocks of data from one location to another without an intervening server. The tape drive assumes the copy manager role normally played by the server. When executing an EXTENDED COPY command, the tape drive acts as a SCSI initiator to establish a connection with a target device and issue READ, WRITE, and other SCSI commands to that device.

Before sending an EXTENDED COPY command to the tape drive, the initiating host must first perform any activities necessary to prepare for the EXTENDED COPY command. These activities may include issuing commands to move a tape in a library to the tape drive, load and position the tape, and determine tape drive and disk status. After all preparatory actions are complete, the host issues an EXTENDED COPY command to the tape drive, which then starts and manages the data transfer.

As shown diagrammatically in FIG. 5, in basic terms the EXTENDED COPY command includes a parameter list length field 5-1; a parameter list header 5-2; a section of target descriptors 5-3; a section of segment descriptors 5-4; and (optionally) a section of inline data 5-5.

The parameter list length field 5-1 specifies the total number of bytes to be transferred in the parameter list, including the parameter list header 5-2, the target descriptors of section 5-3; the segment descriptors of section 5-4; and (optionally) the inline data of section 5-5.

The parameter list header 5-2 includes a target descriptor list length field 5-2T; a segment descriptor list length field 5-2S; and (optionally) an inline data length field S-2D.

The Parameter List Header 5-2 is followed by one or more target descriptors in section 5-3. There is one target descriptor for each supported target device referenced in the command. These devices are the source or the destination for data transferred by the tape drive when executing an EXTENDED COPY command. A maximum of 16 target descriptors is allowed in each parameter list. The format of the target descriptor depends on how the target is identified. The tape drive supports identifying the target by either its Fibre Channel world-wide name or by its N_Port ID.

The data to be transferred during an extended copy operation can be divided into multiple segments. Each segment is described by a segment descriptor in section 5-4. The segment descriptor includes parameters that associate the segment with a target that is identified by its position, or index, in the Target Descriptor List. The index for a target descriptor is preferably computed by subtracting 16 from the starting byte number for the target descriptor in the Parameter List and dividing the result by 32. In one implementation, the maximum number of segment descriptors allowed in a single EXTENDED COPY parameter list is 4,096, each with a maximum length of 16 MB.

When processing a segment descriptor, the tape drive generally performs the following operations:

Retrieves source data from the source device by issuing READ commands. The tape drive performs just enough whole-block read operations to supply the number of blocks or bytes specified in the segment descriptor. If there is residual data from previous segments, this data is included when determining how many read operations to perform. If any residual source data from previous source segments is present, the tape drive reads it before reading any new source data. This behavior is dependent on values of certain Pad and CAT fields (9n the Target Descriptor and Segment Descriptor, respectively) of the EXTENDED COPY command.

Processes the data by taking bytes from the source data and re-designating them as destination data intended for transfer to the destination device. The data is not changed in any other way. If any residual source data from previous source segments is present, the tape drive processes it before processing the source data from the current read operation. Again, this behavior is dependent on values of certain Pad and CAT fields (9n the Target Descriptor and Segment Descriptor, respectively) of the EXTENDED COPY command.

Writes some or all of the destination data to the destination device. The tape drive performs as many whole-block write operations as possible to transfer the destination data and any residual data from previous segments. If any residual destination data from previous segments is present, the tape drive processes it before processing the destination data from the current write operation.

Once invoked, the parameter list parser 64, which is a state machine, has various states such as the basic states illustrated in FIG. 6. Among the states of parameter list parser 64 are store parameter list function/state 64-1; convert target descriptors to array state 64-2; and, segment descriptors parsing state 64-3.

In store parameter list function/state 64-1, the parameter list of the EXTENDED COPY command is stored in processor memory as received from the host. As explained with reference to FIG. 5, the parameter list includes target and segment descriptors and embedded and inline data. In converting target descriptors to array state 64-2, the target descriptors of the parameter list are read and converted to an array of target descriptors (e.g., the segment command array).

The segment descriptors parsing state 64-3 is invoked as needed, reflecting the fact that the segment descriptors are parsed as needed during execution of the EXTENDED COPY command. The segment descriptors parsing state 64-3 is employed to parse the segment descriptors, and is utilized by both source state machine 66 and destination state machine 68. Each of the segment descriptors is referenced/differentiated with an index value. The segment descriptors parsing state 64-3 provides for each segment descriptor pertinent information, such as how many bytes to read or write to a source or target device, how many bytes to copy to hold data, what inline/embedded data (with offsets) needs to be copied to the SDRAM buffer 74, etc. The only time data copying need be done by segment descriptors parsing state 64-3 is when inline or embedded data needs to be inserted in the middle of data read from the source device and the source data cannot be read in such a way as to leave room for the inserted data. Embedded and inline data are processed in essentially the same way, so they are flagged in the same manner.

For simplicity, both the source state machine 66 and destination state machine 68 have comparable structure and are preferably coded into a single function. This function, whether serving as source state machine 66 or destination state machine 68, works on an array (e.g., the array prepared by convert target descriptors to array state 64-2 which contains the source information or destination information, as appropriate. Each command transmitted to the source state machine 66 or destination state machine 68 includes the information necessary for interfacing with the source or destination target devices.

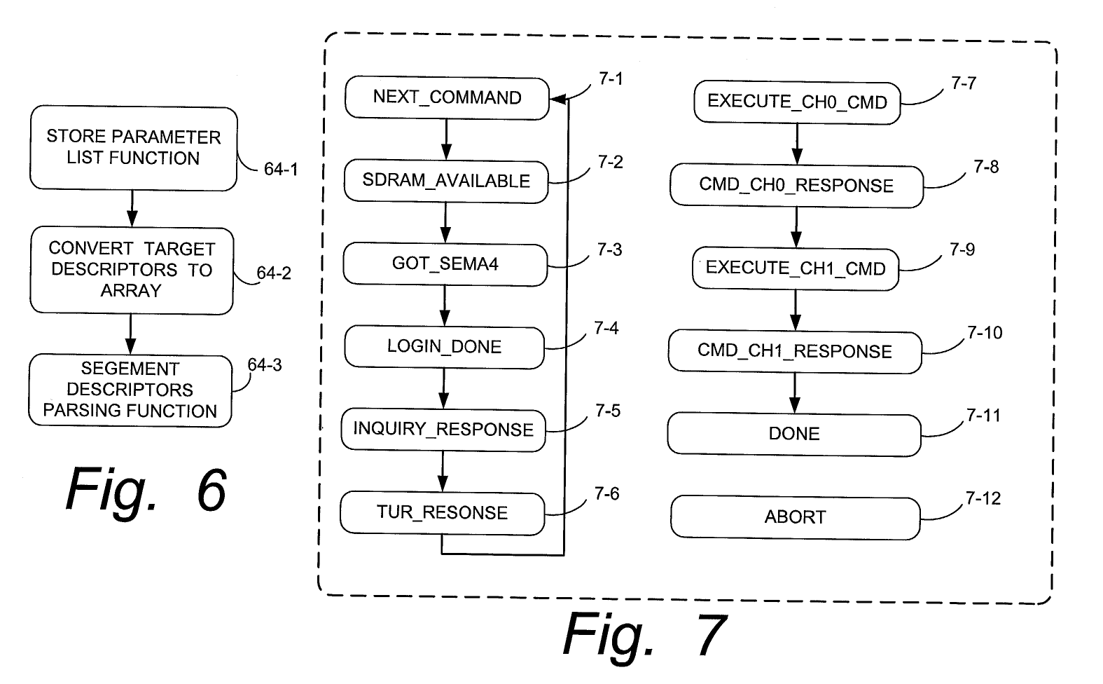

FIG. 7 shows various states which are common to both source state machine 66 and destination state machine 68. The NEXT_COMMAND state 7-1 is the main entry point to the source/destination state machine processing. The NEXT_COMMAND state 7-1 is entered upon receipt of a command from segment descriptors parsing state 64-3. Prior to processing the command, availability of the buffer 74 is checked and insured. Additionally, in the NEXT_COMMAND state 7-1 a check is made for the start of a new segment, end of the current segment, and the specific type of memory moves such as Hold Data, Inline Data, PAD, and other Memory Moves.

SDRAM_AVAILABLE state 7-2 is the next state for the source/destination state machine. In the SDRAM_AVAILABLE state 7-2 the buffer 74 is confirmed as available (indicating that destination state machine 68 is not ahead of the source device, nor is the source device at risk of overwriting the current destination segment in process). Once this is determined, the operative machine (either source state machine 66 or destination state machine 68) must acquire a register access semaphore for buffer 74. This semaphore insures that the register setup functions for buffer 74 performed by source state machine 66 will not adversely affect those in process by the destination state machine 68 and vice versa.

Attaining to GOT_SEMA4 state 7-3 indicates that the operative machine (source state machine 66 or destination state machine 68) has received the register access semaphore for buffer 74. The next step is to further determine if the operative machine is supposed to obtain data from tape or target. This next determination is necessary because data transfer to/from an external target device requires logging into that device.

LOGIN_DONE state 7-4 indicates that either a target login was not required (having been previously logged into, or not an external target device) or that the login response came back. The next step after LOGIN_DONE state 7-4 is to check the Segment Command Array to determine if a SCSI INQ (Inquiry) command needs to be sent to the Target device.

In INQUIRY_RESPONSE state 7-5, an inquiry response has come back from the target device. Additionally, a check for correct device type (either block device or streaming device) is performed. Next, a SCSI Test Unit Ready (TUR) command is sent if so indicated in the Command Array at this command index.

TUR_RESPONSE state 7-6 is attained when a response from the TUR has returned. In most cases, the next state from here will be the NEXT_COMMAND state 7-1 because the channel 0 and 1 commands will be in a separate command array element.

States 7-7 through 7-11 are entered by the state machines (e.g., source state machine 66 or destination state machine 68) when the tape drive 26 must read or write to tape. In the particular illustration of FIG. 7, two channels are described, with a first of the channels being denominated as channel CH0 and the second of the channels being denominated as channel CH1. As explained below, the first channel CH0 is toward an appropriate one of the tape write manager 70 and tape drive read manager 72 of the tape drive 26. In other words, CH0 refers to a DMA channel 0 whose actions are coordinated with either the media write manager 70 or the media read manager 72, depending on the direction of data flow. The second channel CH1 is toward the external device, e.g., CH1 refers to a DMA channel 1 whose actions are coordinated with the communication interface 60 and ultimately to the target devices attached thereto.

For the first channel, the EXECUTE_CHO_CMD state 7-7 handles the execution of the tape write or tape read operation by kicking off either the media write manager 70 or media read manager 72 which are internal to I/O drive 26. In the case of source processing with the I/O drive 26 serving as the source device, the media read manager 72 is invoked. On the other hand, in the case of destination processing with the I/O drive 26 serving as the destination device, the media write manager 70 is invoked. The CMD_CH0_RESPONSE state 7-8 is subsequently entered to handle the response from the media write manager 70 or media read manager 72 for the first channel.

EXECUTE_CH1_CMD state 7-9 handles the execution of the target writes and reads by initiating SCSI WRITE and READ commands respectively to the appropriate target device. In the case that the target device is the source, this state will send the SCSI READ command to the target device specified in the Command Array at this command index. For the destination case, a SCSI WRITE command is sent to the target device.

The CMD_CH1_RESPONSE state 7-10 is subsequently entered to handle the response from the tape write manager 70 or tape drive read manager 72 for the second channel. In the case that this target is the source device, the entire amount of data that capable of being received in the SCSI READ command has already been specified, so it is expected that all of the data has been transferred to the tape drive 26, and a simple check for any target errors is performed here. In the case that this is a destination state process, multiple transfer readys are handled by this state machine as well. During target writes, the target will send an XFER_RDY information unit back to this copy manager indicating how much data can be successfully transferred to this target at this time. This amount may be less than the amount requested in the SCSI WRITE sent by the copy manager, so multiple data transfers are handled here in this state.

In DONE state 7-11 the current EXTENDED COPY command has completed, and state machine completed processing all of the commands in the Segment List, as generated by the Segment Descriptors Parsing Function 64-3. Also at this time, the Extended Copy Results are posted so that they can be retrieved by the Receive Copy Results SCSI command. Control is passed back to the Main Extended Copy State Machine 62 from here by sending an event to the link that was passed into this sub-state processing machine.

ABORT state 7-12 handles any abnormal ending of the extended copy processing. Both source state machine 66 and destination state machine 68 have an abort procedure, and either can abort the other if required. Normally, this state is entered if there are problems with the media write manager 70 or media read manager 72 or the target devices.

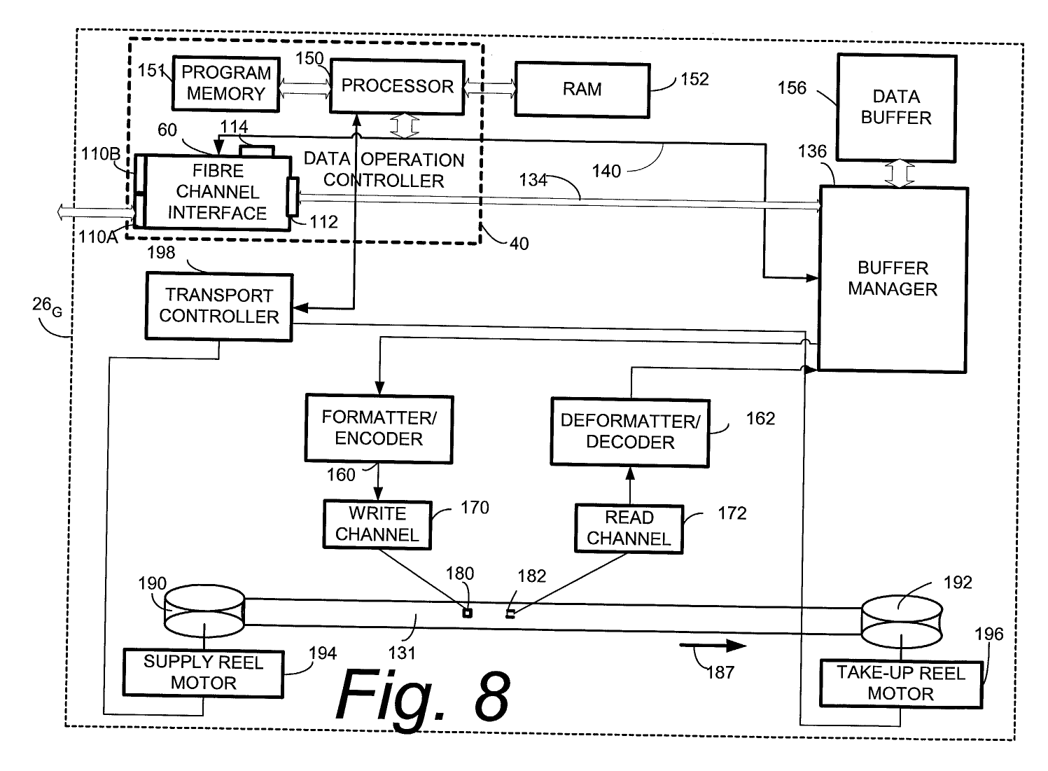

FIG. 8 is a schematic view of selected portions of an example generic tape drive 26_{G} suitable for managing a drive-managed serverless network data storage operation (as, e.g., the I/O drive described generally above). In the illustrated embodiment, communications network 30 is a fibre channel communications network. Such being the case, FIG. 8 shows that tape drive 26_{G} includes the communication interface 60. The communication interface 60 can take the form of an interface subsystem which replaces a SCSI interface subsystem internal to a conventional tape drive. The communication interface 60 has one or port fibre channel ports, such as ports 110A and 110B shown in FIG. 8, for connecting to corresponding independent plural fibre loops. In the illustrated embodiment, port 110A of communication interface 60 is connected to communications network 30. In such event, the interface card for communication interface 60 is connected by connector 112 to an interface board or system backplane of tape drive 26_{G} that provides power and hardware address selection to the ports 110. In addition, communication interface 60 has a two-digit, hexadecimal thumbwheel switch 114 used to set the fibre identification.

The FIG. 8 generic tape drive transduces information to/from tape 131. Data bus 134 connects communication interface 60 to buffer manager 136. Both communication interface 60 and buffer manager 136 are connected by a bus system 140 to processor 150. Processor 150 is also connected to program memory 151 and to a data memory, particularly RAM 152.

Buffer manager 136 controls, e.g., both storage of user data in buffer memory 156 and retrieval of user data from buffer memory 156. In the context of the drive-managed serverless network data storage operation, user data is data obtained from communications network 30 (and particularly disk array 28) for recording on tape 31, or data destined from tape 31 to an element of communications network 30 (e.g., disk array 28). Buffer manager 136 is also connected to formatter/encoder 160 and to deformatter/decoder 162. Formatter/encoder 160 and deformatter/decoder 162 are, in turn, respectively connected to write channel 170 and read channel 172. Write channel 170 is connected via a write amplifier 174 to one or more recording element(s) or write head(s) 180; read channel 172 is connected via a read amplifier to one or more read element(s) or read head(s) 182.

Those skilled in the art will appreciate that write channel 170 includes various circuits and elements such as a RLL modulator, a parallel-to-serial converter, and write current modulator. Similarly, the person skilled in the art understands that read channel 172 includes elements such as a data pattern and clock recovery circuitry, a serial-to-parallel converter, and, an RLL demodulator. These and other aspects of tape drive 26_{G}, including servo control and error correction, are not necessary for an understanding of the invention and accordingly are not specifically described herein.

In the illustrated embodiment, tape 131 is transported in a direction indicated by arrow 187 from a supply reel 190 to a take-up reel 192. Supply reel 190 and take-up reel 192 are typically housed in an unillustrated cartridge or cassette from which tape 131 is extracted into a tape path. Motion can be imparted to tape 131 in several ways, including by a capstan, for example. Alternatively or additionally, motion can be provided by reel motors, such as supply reel motor 194 for supply reel 190 and take-up reel motor 196 for take-up reel 192. One or more of the supply reel motor 194 and take-up reel motor 196 are controlled by a transport controller 198. The transport controller 198 is connected to processor 150.

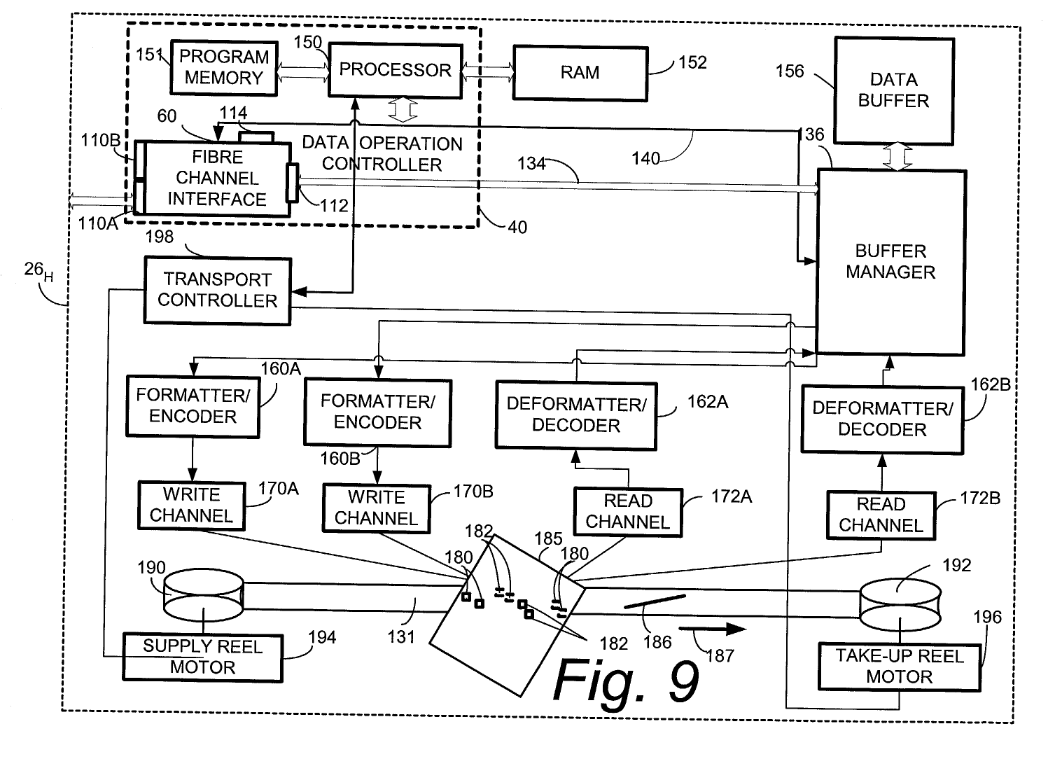

FIG. 9 shows a more specialized embodiment in which the tape drive that manages the serverless network data storage operation is a helical scan tape drive 26_{H}. In a helical scan tape drive, the tape 131 is transported proximate a rotating scanner or drum 185. The drum preferably has plural write heads 180 and plural read heads 182 mounted thereon. Moreover, the tape drive 26_{H} may have plural write channels and plural read channels, such as write channel 170A and write channel 170B, and read channel 172A and read channel 172B, all as illustrated in FIG. 9. Write head(s) 180 and read head(s) 182 are situated on a peripheral surface of rotating drum 185. Tape 131 is wrapped around drum 185 such that head(s) 180 and 182 follow helical stripes 186 on tape 131 as tape 131 is transported in a direction indicated by arrow 187 from supply reel 190 to a take-up reel 192.

Examples of helical scan tape drives generally are those manufactured by Exabyte Corporation, and which are illustrated, e.g., in U.S. Pat. No. 4,843,495; U.S. Pat. No. 4,845,577; U.S. Pat. No. 5,050,018; U.S. Pat. No. 5,065,261; U.S. Pat. No. 5,068,757; U.S. Pat. No. 5,142,422; U.S. Pat. No. 5,191,491; U.S. Pat. No. 5,535,068; U.S. Pat. No. 5,602,694; U.S. Pat. No. 5,680,269; U.S. Pat. No. 5,689,382; U.S. Pat. No. 5,726,826; U.S. Pat. No. 5,731,921; U.S. Pat. No. 5,734,518; U.S. Pat. No. 5,953,177; U.S. Pat. No. 5,973,875; U.S. Pat. No. 5,978,165; U.S. Pat. No. 6,144,518; and, U.S. Pat. No. 6,288,864, all of which are incorporated herein by reference.

Advantageously, providing a data operation controller 40 in an I/O drive such as a tape drive allows data transfer of the I/O drive to approach or equal its native data transfer rate during the serverless network data storage operation. By contrast, in a conventional system in which a network data storage operation is managed outside of the I/O drive, the I/O drive typically operates at a data transfer rate which is significantly below its native rate, particularly when the network data storage operation involves plural destination or source drives.

Thus, in accordance with the present invention, provision of the data operation controller 40 in an I/O drive enables the I/O drive to achieve a data transfer rate at or near its native data transfer rate. In one example implementation in which the I/O drive is a helical scan tape drive, the data transfer rate obtained when implementing the present invention reaches as high as 30 Megabytes per second (in contrast to 1 to 2 Megabytes per second as experienced by the same type of drive in a conventional serverless backup system).

The present invention also advantageously promotes the scalability of storage area networks, as the number of I/O drives involved in a serverless network data storage operation can be increased without appreciably affecting data transfer rate or otherwise degrading the overall operation.

For a library embodiment such as shown in FIG. 2, each of the plural tape drives 26 has its own data operation controller 40. In having its own data operation controller, each tape drive can handle its own data stream for the serverless network data storage operation and thereby avoid bottlenecks to which libraries are otherwise susceptible when all data flows are commonly handled.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

TABLE 1

| Command | Explanation |
|---|---|
| EXTENDED | The EXTENDED COPY command allows the I/O drive |
| COPY | to act as a SCSI initiator to establish a connection with a |
| | target disk and issue Read, Write, and other SCSI |
| | commands to the disk. |
| RECEIVE | The new RECEIVE COPY RESULTS command is used |
| COPY | to return the results of a previous (or current) |
| RESULTS | EXTENDED COPY command |
| REPORT | The REPORT LUNS command requests that the target |
| LUNS | device report its LUN (Logical Unit Number) to the |
| | initiator. |
| INQUIRY | The I/O drive reports its world-wide names through the |
| | INQUIRY command on the Device Identification |
| MODE | Additional pages have been added to the MODE |
| SELECT and | SELECT and MODE SENSE commands to support the |
| MODE SENSE | Fibre Channel communication protocol transport. |
| REQUEST | The sense data returned by the I/O drive when it is |
| SENSE | acting as a copy manager while processing an |
| | EXTENDED COPY command has been modified. In |
| | addition to sense data related specifically to the |
| | EXTENDED COPY command, the I/O drive preserves |
| | any sense data returned to it by the devices involved in |
| | the copy operation. The I/O drive then appends this |
| | sense data to the EXTENDED COPY sense data. New |
| | SCSI hardware error codes (Sense Key 4 h) and Fault |
| | Symptom Codes have been added to reflect the |
| | Communication interface. |

What is claimed is:

1. A magnetic tape drive for use in a storage network, the storage network including a server, a source drive which transduces information relative to a source drive storage medium, and a destination drive which transduces information relative to a destination drive storage medium, the magnetic tape drive comprising:
at least one transducing element which tranduces information relative to a magnetic tape;
a tape transport system which transports the magnetic tape proximate the transducing element;
an interface to the storage network;
a controller which manages a serverless network data storage operation in which data is obtained from the source drive storage medium at the source drive, transmitted through the interface to the storage network, and then recorded by the destination drive on the destination drive storage medium.

2. The apparatus of claim 1, wherein the destination drive is the tape drive and the destination drive storage medium is the magnetic tape.

3. The apparatus of claim 1, wherein the source drive is the tape drive and the source drive storage medium is the magnetic tape.

4. The apparatus of claim 1, wherein one of the source drive and the destination drive is an external drive situated at an external node of the storage network apart from a node whereat the tape drive resides.

5. The apparatus of claim 4, wherein the external drive is a disk drive.

6. The apparatus of claim 4, wherein the external drive is a disk drive situated at a node of the storage network which is distinct from a node whereat the server resides.

7. The apparatus of claim 4, wherein the external drive is a second tape drive.

8. The apparatus of claim 1, wherein the interface is a fibre channel interface.

9. The apparatus of claim 1, wherein the tape drive is a helical scan tape drive which transduces information in helical tracks on the magnetic tape.

10. The apparatus of claim 1, wherein the controller generates input/output commands to at least one of the source drive and the destination drive.

11. A storage area network comprising:
a server;
a source drive which transduces information relative to a source drive storage medium;
a destination drive which transduces information relative to a destination drive storage medium;
a magnetic tape drive, the magnetic tape drive comprising:
at least one transducing element which tranduces information relative to a magnetic tape;
a tape transport system which transports the magnetic tape proximate the transducing element;
an interface to the storage network;
a controller which manages a serverless network data storage operation in which data is obtained from the source drive storage medium at the source drive, transmitted through the interface to the storage network, and then recorded by the destination drive on the destination drive storage medium.

12. The apparatus of claim 11, wherein the destination drive is the tape drive and the destination drive storage medium is the magnetic tape.

13. The apparatus of claim 11, wherein the source drive is the tape drive and the source drive storage medium is the magnetic tape.

14. The apparatus of claim 11, wherein one of the source drive and the destination drive is an external drive situated at an external node of the storage network apart from a node whereat the tape drive resides.

15. The apparatus of claim 14, wherein the external drive is a disk drive.

16. The apparatus of claim 14, wherein the external drive is a disk drive situated at a node of the storage network which is distinct from a node whereat the server resides.

17. The apparatus of claim 14, wherein the external drive is a second tape drive.

18. The apparatus of claim 11, wherein the interface is a fibre channel interface.

19. The apparatus of claim 11, wherein the tape drive is a helical scan tape drive which transduces information in helical tracks on the magnetic tape.

20. The apparatus of claim 11, wherein the controller generates input/output commands to at least one of the source drive and the destination drive.

21. An automated information storage library for use in a storage network, the storage network including a server and a disk drive which transduces information relative to a disk, the automated information storage library comprising:
a storage cell for accommodating a cartridge of magnetic tape;
a magnetic tape drive;
a cartridge transport system which transports the cartridge between the storage cell and the tape drive;
wherein the tape drive comprise:
at least one transducing element which tranduces information relative to a magnetic tape;
a tape transport system which transports the magnetic tape proximate the transducing element;
an interface to the storage network;
a controller which manages a serverless network data storage operation in which data is obtained from the source drive storage medium at the source drive, transmitted through the interface to the storage network, and then recorded by the destination drive on the destination drive storage medium.

22. The apparatus of claim 21, wherein the destination drive is the tape drive and the destination drive storage medium is the magnetic tape.

23. The apparatus of claim 21, wherein the source drive is the tape drive and the source drive storage medium is the magnetic tape.

24. The apparatus of claim 21, wherein one of the source drive and the destination drive is an external drive situated at an external node of the storage network apart from a node whereat the tape drive resides.

25. The apparatus of claim 24, wherein the external drive is a disk drive.

26. The apparatus of claim 24, wherein the external drive is a disk drive situated at a node of the storage network which is distinct from a node whereat the server resides.

27. The apparatus of claim 24, wherein the external drive is a second tape drive.

28. The apparatus of claim 21, wherein the interface is a fibre channel interface.

29. The apparatus of claim 21, wherein the tape drive is a helical scan tape drive which transduces information in helical tracks on the magnetic tape.

30. The apparatus of claim 21, wherein the controller generates input/output commands to at least one of the source drive and the destination drive.

31. A method of operating a storage area network comprising:
initiating a serverless network data storage operation wherein data is obtained from a source drive storage medium at a source drive, transmitted through the storage area network, and then recorded by a destination drive on a destination drive storage medium;
managing the serverless network data storage operation at tape drive, including using the tape drive to generate input/output commands to at least one of the source drive and the destination drive.

32. The method of claim 31, wherein the destination drive is the tape drive and the destination drive storage medium is magnetic tape.

33. The method of claim 31, wherein the source drive is the tape drive and the source drive storage medium is magnetic tape.

34. The method of claim 31, wherein one of the source drive and the destination drive is an external drive situated at an external node of the storage network apart from a node whereat the tape drive resides.

35. The method of claim 34, wherein the external drive is a disk drive.

36. The method of claim 34, wherein the external drive is a disk drive situated at a node of the storage network which is distinct from a node whereat a server resides.

37. The method of claim 34, wherein the external drive is a second tape drive.

38. The method of claim 31, wherein the interface is a fibre channel interface.

39. The method of claim 31, wherein the tape drive is a helical scan tape drive which transduces information in helical tracks on the magnetic tape.

40. An I/O drive for use in a storage network, the storage network including a server, a source drive which transduces information relative to a source drive storage medium, and a destination drive which transduces information relative to a destination drive storage medium, the I/O drive comprising:
at least one transducing element which tranduces information relative to media handled by the I/O drive;
an interface to the storage network;
a controller which manages a serverless network data storage operation in which data is obtained from the source drive storage medium at the source drive, transmitted through the interface to the storage network, and then recorded by the destination drive on the destination drive storage medium.

41. The apparatus of claim 40, wherein the destination drive is the I/O drive and the destination drive storage medium is the media handled by the I/O drive.

42. The apparatus of claim 40, wherein the source drive is the I/O drive and the source drive storage medium is the media handled by the I/O drive.

43. The apparatus of claim 40, wherein one of the source drive and the destination drive is an external drive situated at an external node of the storage network apart from a node whereat the I/O drive resides.

44. The apparatus of claim 43, wherein the external drive is a disk drive.

45. The apparatus of claim 43, wherein the external drive is a disk drive situated at a node of the storage network which is distinct from a node whereat the server resides.

46. The apparatus of claim 43, wherein the external drive is a tape drive.

47. The apparatus of claim 40, wherein the interface is a fibre channel interface.

48. The apparatus of claim 40, wherein the controller generates input/output commands to at least one of the source drive and the destination drive.

49. A storage area network comprising:
a server;
a source drive which transduces information relative to a source drive storage medium;
a destination drive which transduces information relative to a destination drive storage medium;
an I/O drive comprising:
at least one transducing element which tranduces information relative to media handled by the I/O drive;
an interface to the storage network;
a controller which manages a serverless network data storage operation in which data is obtained from the source drive storage medium at the source drive, transmitted through the interface to the storage network, and then recorded by the destination drive on the destination drive storage medium.

50. The apparatus of claim 49, wherein the destination drive is the I/O drive and the destination drive storage medium is the media handled by the I/O drive.

51. The apparatus of claim 49, wherein the source drive is the I/O drive and the source drive storage medium is the media handled by the I/O drive.

52. The apparatus of claim 49, wherein one of the source drive and the destination drive is an external drive situated at an external node of the storage network apart from a node whereat the I/O drive resides.

53. The apparatus of claim 52, wherein the external drive is a disk drive.

54. The apparatus of claim 52, wherein the external drive is a disk drive situated at a node of the storage network which is distinct from a node whereat the server resides.

55. The apparatus of claim 52, wherein the external drive is a tape drive.

56. The apparatus of claim 49, wherein the interface is a fibre channel interface.

57. The apparatus of claim 49, wherein the controller generates input/output commands to at least one of the source drive and the destination drive.

58. A method of operating a storage area network comprising:
initiating a serverless network data storage operation wherein data is obtained from a source drive storage medium at a source drive, transmitted through the storage area network, and then recorded by a destination drive on a destination drive storage medium;
managing the serverless network data storage operation at a peripheral node I/O drive, including using the I/O drive to generate input/output commands to at least one of the source drive and the destination drive.

59. The method of claim 58, wherein the destination drive is the I/O drive and the destination drive storage medium is media handled by the I/O drive.

60. The method of claim 58, wherein the source drive is the I/O drive and the source drive storage medium is media handled by the I/O drive.

61. The method of claim 58, wherein one of the source drive and the destination drive is an external drive situated at an external node of the storage network apart from a node whereat the I/O drive resides.

62. The method of claim 61, wherein the external drive is a disk drive.

63. The method of claim 61, wherein the external drive is a disk drive situated at a node of the storage network which is distinct from a node whereat a server resides.

64. The method of claim 61, wherein the external drive is a tape drive.

65. The method of claim 58, wherein the interface is a fibre channel interface.
